(19) United States
(12) Patent Application Publication
(10) Pub. No.: US 2006/0143926 A1
(43) Pub. Date: Jul. 6, 2006

(54) Hair trimmer with extendable handle and movable guide

(75) Inventors: Anand Khubani, Towaco, NJ (US); Aaron Szymanski, Thomaston, CT (US)

Correspondence Address: EPSTEIN DRANGEL BAZERMAN & JAMES, LLP, 60 EAST 42ND STREET, SUITE 820, NEW YORK, NY, 10165, US

(73) Assignee: Ideavillage Products Corp.

(21) Appl. No.: 11/029,230

(22) Filed: Jan. 4, 2005

(51) Int. Cl. B26B 21/00

(52) U.S. Cl. 30/53

(57) ABSTRACT

The hair trimmer includes a housing. A moveable blade is mounted on the housing. A handle defines a recess into which at least a part of the housing is slideably received. The handle is moveable relative to the housing between a retracted position and an extended position to extend the reach of the trimmer. A guide is mounted for movement relative to the housing between a retracted position, wherein the teeth of the blade are exposed, and an extended position, wherein the guide extends beyond the teeth of the blade to protect the skin.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to electric hair trimmers useful for removing body hair and more particularly to such a hair trimmer with an extendable handle to increase the reach of the trimmer for removal of hair from hard to reach areas of the body and a movable guide to shield the skin from the blades to prevent irritation thereof

2. Description of Prior Art Including Information Disclosed Under 37 CFR 1.97 and 1.98

Electrically driven hair trimmers of various different types are well known in the art. Some trimmers are designed for general use anywhere on the body while others are intended for the removal of hair from specific areas of the body, such as the face.

However, certain areas of the body, for example, the back of the neck or on the upper back, are difficult to reach and thus conventional trimmers cannot be conveniently used for hair removal from those areas, without assistance. One object of the present invention is to provide a hair trimmer with an extendable handle that facilitates the use of the trimmer for removal of hair from the hard to reach areas of the body.

Further, in hair trimmers with exposed blades, one of which is driven to reciprocate relative to the other, can abrade and irritate the skin during the hair removal procedure, if placed directly on the skin. However, it is difficult to avoid placing the blades against the skin when removing hair from hard to reach areas. It is often impossible to see the blades when situated in those areas. Without being able to observe the blades of the trimmer, it is hard to accurately position the trimmer such that the blades are spaced from but close to the skin. Accordingly, abrasion and irritation commonly result from such trimming operations. It is therefore another object of the present invention to provide a hair trimmer with a guide that can be moved to a position slightly beyond the blades so as to prevent the blades from coming into direct contact with the skin during the trimming operation.

In accordance with one aspect of the present invention, a hair trimmer is provided including a housing, with a moveable blade mounted thereon. A handle is provided with a recess into which at least a part of the housing is slideably received. The handle can be moved relative to the housing between a retracted position and an extended position so as to increase the reach of the trimmer.

The trimmer also includes detent means operably interposed between the handle and the housing. Detent means engaging means are also provided.

The detent means preferably includes first and second oppositely directed detents. In the preferred embodiment, the detents are mounted on opposing exterior surfaces of the housing.

The detent means engaging means preferably includes first and second oppositely directed protrusions. In the preferred embodiment, the detent engaging means are protrusions extending inwardly from oppose interior surfaces of the handle.

The housing has a recess adapted to receive a battery. The handle is moveable to a third position relative to the housing to expose the battery receiving recess, in order to permit battery replacement.

The trimmer also includes a guide mounted on the housing, proximate the blade. Means are provided for mounting the guide on the housing for movement relative to the housing between a retracted position, wherein the blade is exposed and an extended position, wherein the guide extends beyond the blade.

The trimmer guide has a comb-like configuration. It includes a base and a plurality of spaced teeth extending from the base.

The interior surface of base of the guide has protruding means, preferably in the form of a member with a transversely extending head. The housing has protrusion receiving means in the form of an elongated slot. The slot is adapted to moveably receive the member. The slot has a transversely extending portion adopted to receive the head of the member.

The trimmer housing has a recess adapted to receive the guide. The guide is substantially received within the recess in the retracted position.

In accordance with another aspect of the present invention, a hair trimmer is provided having a housing with a movable blade mounted thereon. A guide is provided, as are means for mounting the guide on the housing for movement between a retracted position, wherein the blade is exposed, and an extended position, wherein the guide extends beyond the blade.

The guide has a comb-like configuration. It includes a base and a plurality of spaced teeth extending from the base. Preferably, the teeth are arcuate.

The guide mounting means includes protrusion means and protrusion receiving means. The protrusion means preferably extends from the interior surface of base of the guide. In the preferred embodiment, it takes the form of a member with a transversely extending head. The housing has the protrusion receiving means, preferably in the form of an elongated slot adapted to moveably receive the member. The slot has a transversely extending portion adopted to receive the head of the member.

The trimmer housing has a recess adapted to receive the guide. The guide is substantially received within the recess, when in its retracted position.

The trimmer also includes a handle. The handle is extendable relative to the housing to increase the reach of the trimmer.

In accordance with another aspect of the present invention, a hair trimmer is provided including a housing with a movable blade mounted thereon. A handle is provided with a recess into which at least a part of the housing is slideably received. The handle is moveable relative to the housing, between a retracted position and an extended position. A guide is provided, as is means for mounting the guide on the housing for movement between a retracted position, wherein the blade is exposed and an extended position, wherein extends beyond the blade.

### BRIEF DESCRIPTION OF THE SEVERAL VIEWS OF DRAWINGS

To those, and to such other objects that may hereinafter appear, the present invention relates to a hair trimmer with an extendable handle and a movable guide, as set forth in detail in the following specification and recited in the annexed claims, taken together with the accompanying drawings, wherein like numerals refer to like parts and in which:

FIG. 1 is a view of the back of the head and neck of a person using the trimmer of the present invention, showing the handle in the extended position and the end of the guide extending beyond the blade;

FIG. 2 is an isometric view of the trimmer of the present invention showing the handle and the guide in their respective retracted positions;

FIG. 3 is a view similar to that of FIG. 2 but showing the handle and guide in their respective extended positions;

FIG. 4 is an exploded isometric view showing the details of the forward portion of the housing and the interior of the guide;

FIG. 5 is a side plan view taken along line 5-5 of FIG. 4;

FIG. 6 is an isometric view of the trimmer showing the handle in the third position relative to the housing, permitting replacement of the battery;

FIG. 7 is a side plan view of the rear portion of the housing showing the detents in cross-section;

FIG. 8 is a cross-sectional view taken along line 8-8 of FIG. 6;

FIG. 9 is a cross-sectional view of the handle taken along line 9-9 of FIG. 6;

FIG. 10 is a side plan view of the trimmer with the handle in the retracted position, showing the detents cooperating with one set of detent engaging protrusions; and

FIG. 11 is a side plan view of the trimmer with the handle in the extended position, showing the detents cooperating with the second set of detent engaging protrusions.

### DETAILED DESCRIPTION OF THE INVENTION

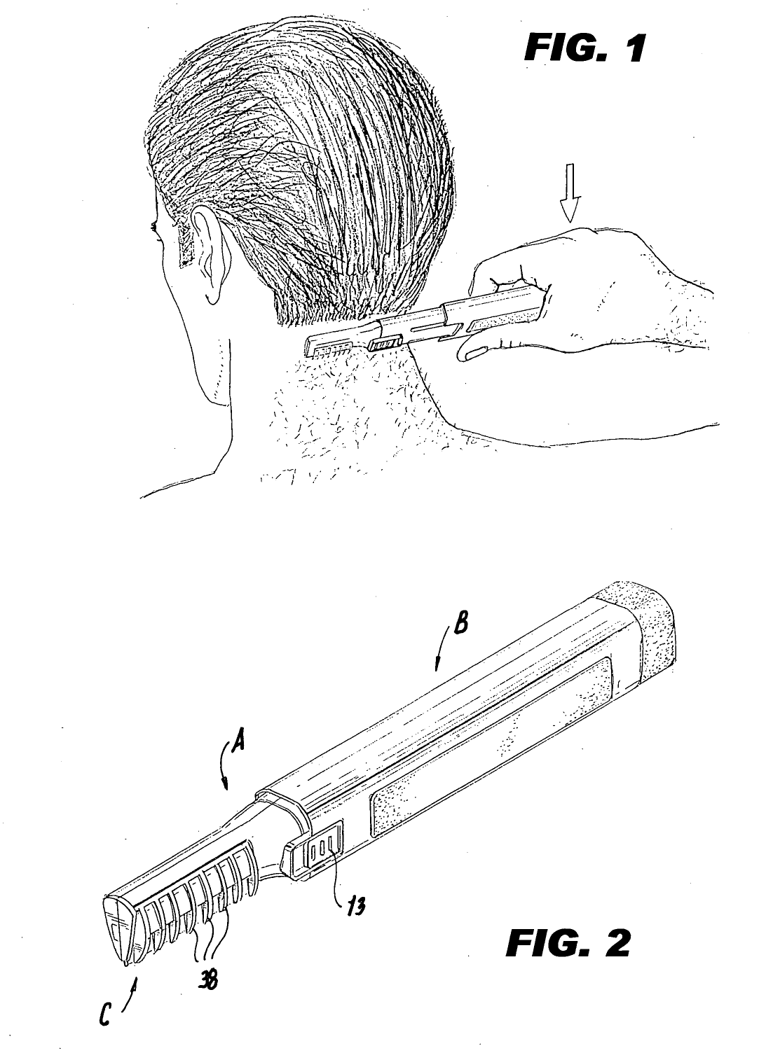

The present invention is a portable, handle held, battery operated hair trimmer designed for removing hair from hard to reach areas of the body, such as the back of the neck, as seem in FIG. 1. To achieve that result, the trimmer is provided with an extendable handle to extend the reach of the trimmer and a retractable guide to prevent the cutting blades from directly contacting the skin, to reduce the possibility of irritation.

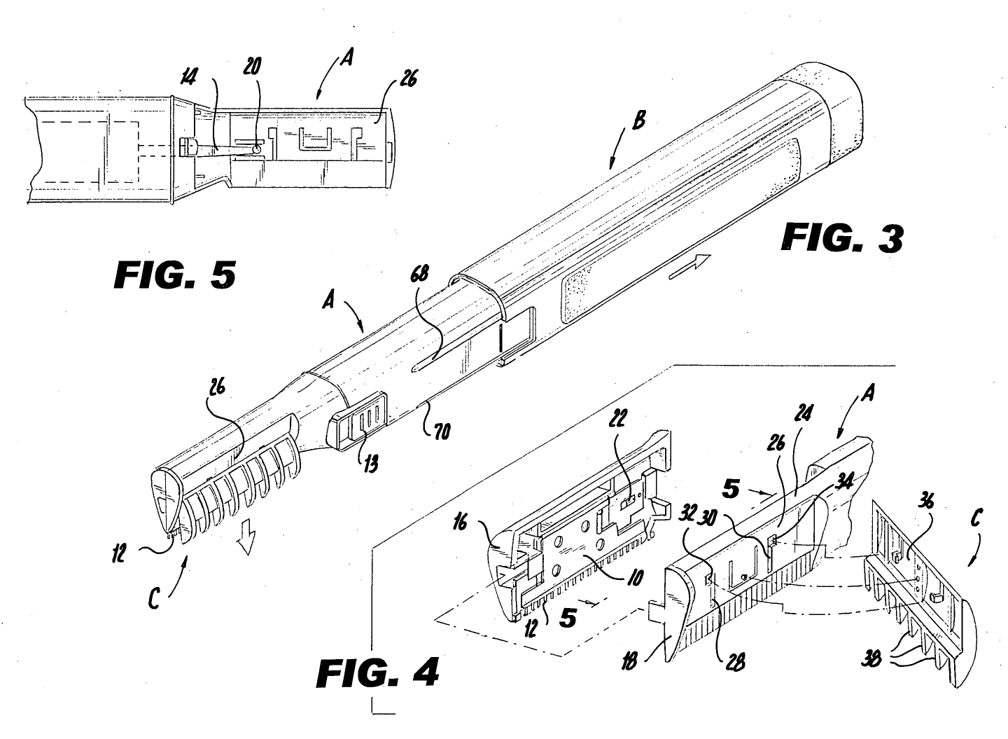

As best seen in FIGS. 2 and 3, the trimmer comprises a housing, generally designated A, and a handle, generally designated B. Housing A is generally elongated in configuration and at the front end thereof carries a moveably mounted blade 10 and an adjacent fixed blade 12 (see FIG. 4) in side-by-side relation.

Housing A contains an electric motor with a rotatable output shaft connected to a mechanical linkage, all of which is conventional, forms no part of the present invention and are not shown. The mechanical linkage drives a reciprocating member 14 (see FIG. 5) which in turn is connected to moveable blade 10 in a conventional manner so as to reciprocate blade 10 relative to fixed blade 12 in a direction substantially along the axis of the housing. The motor is connected to be energized by a battery situated within the housing by an externally accessible slide switch 13.

Moveably attached to one side of the forward portion of the housing, adjacent the blades, is a comb-like guide, generally designated C. As illustrated in FIGS. 2 and 3, guide C can be moved relative to the housing, in a direction substantially perpendicular to the axis thereof, between a retracted position (FIG. 2), wherein the teeth of the blades are exposed, and an extended position (FIG. 3), wherein the ends of the teeth of the guide are situated beyond the blade teeth to an extent sufficient to protect the skin from direct contact with the blade teeth, when the forward portion of the housing is pressed against the skin.

As seen in FIG. 4, housing A includes a first housing section half 16 and a second housing section half 18 that together form the forward portion of the housing. Blade 10 is carried by housing section half 16. Blade 10 is mounted on the housing for movement in the direction of the housing axis.

Blade 10 is mechanically connected to member 14. More specifically, the surface of member 14 carries a protrusion 20 that is adapted to be received in a recess 22 in the rear portion of blade 10. Thus, as member 14 is reciprocated, the reciprocating motion of the member is transferred to blade 10.

Housing section 18 includes a guide receiving recess 24 defined in part by a substantially planar wall 26 from which the teeth that form the fixed blade 12 extend. Wall 26 has spaced, substantially parallel elongated slots 28, 30 that extend in a direction substantially perpendicular to the axis of housing A and hence to the direction of movement of Blade 10. Each of the slots 28, 30 has an oppositely extending transverse section 32, 34, respectively, located at the top thereof.

Guide C includes a base 36 and a plurality of teeth 38 extending downwardly from the bottom of the base. Preferably, the exterior surface of the guide base and teeth is arcuate such that when the guide is retracted, the arcuate exterior surface of the guide is similar in curvature to that of the exterior of the forward portion of the housing.

The interior surface of base 36 carries a pair of spaced protrusions 40, 42. Each of the protrusions 40, 42 has a transversely extending end 44, 46 respectively that is directed inwardly, toward the other protrusion end. Ends 44, 46 are adapted to be received through transverse slot sections 32, 34 respectively such that protrusions 40, 42 are received in, and moveable along, slots 28, 30 respectively to permit the guide to be moved relative to the housing between the retracted and extended positions.

The handle can be moved relative to the housing between retracted, extended and replacement positions. Detent means and detent engaging means cooperate to retain the handle in the retracted and extended positions relative to the housing.

The detent means are illustrated in FIG. 7. The housing has top and bottom exterior surfaces 48, 50. Extending from each of the surfaces 48, 50 is a detent 52, 54, respectively. Detents 52, 54 are formed of resilient material, such as metal, such that they can be deformed to a small extent by the application of an external force and will return to their original, undeformed state, once the force is removed.

The detent engaging means consist of first and second sets of protrusions 56, 58 and 60, 62 situated at spaced locations on the top and bottom interior surfaces of handle A. Those protrusions apply an external force to the detents, causing the detents to deform slightly, as they pass over the protrusions.

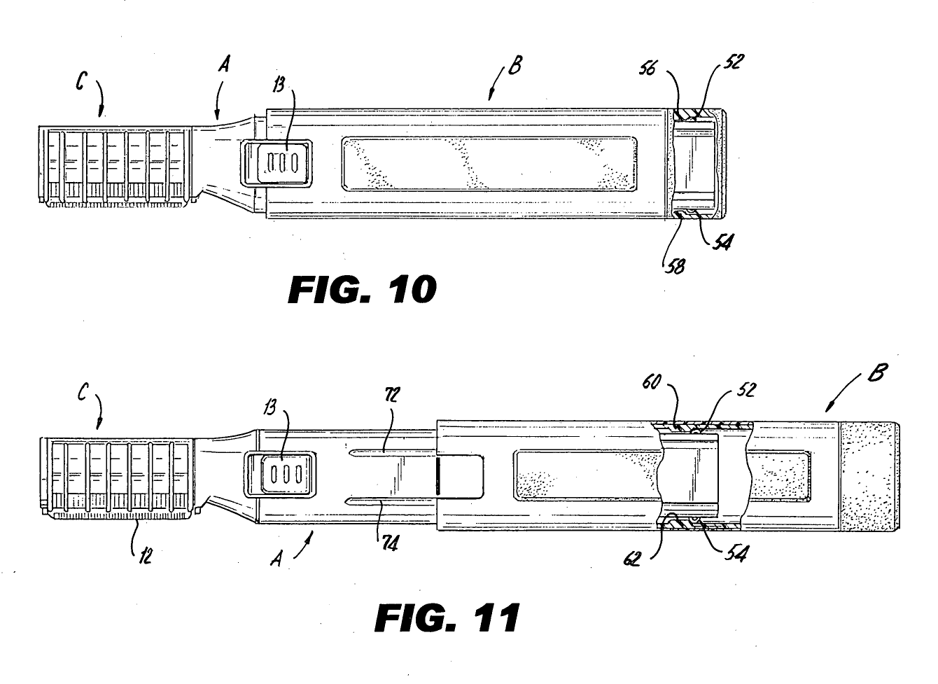

FIG. 8 illustrates protrusions 60, 62, which are shown there in cross-section. FIG. 10 shows the cooperation between detents 52, 54 and protrusions 56, 58 to retain the handle in its retracted position. FIG. 11 shows the cooperation between detents 52, 54 and protrusions 60, 62 to retain the handle in the extended position.

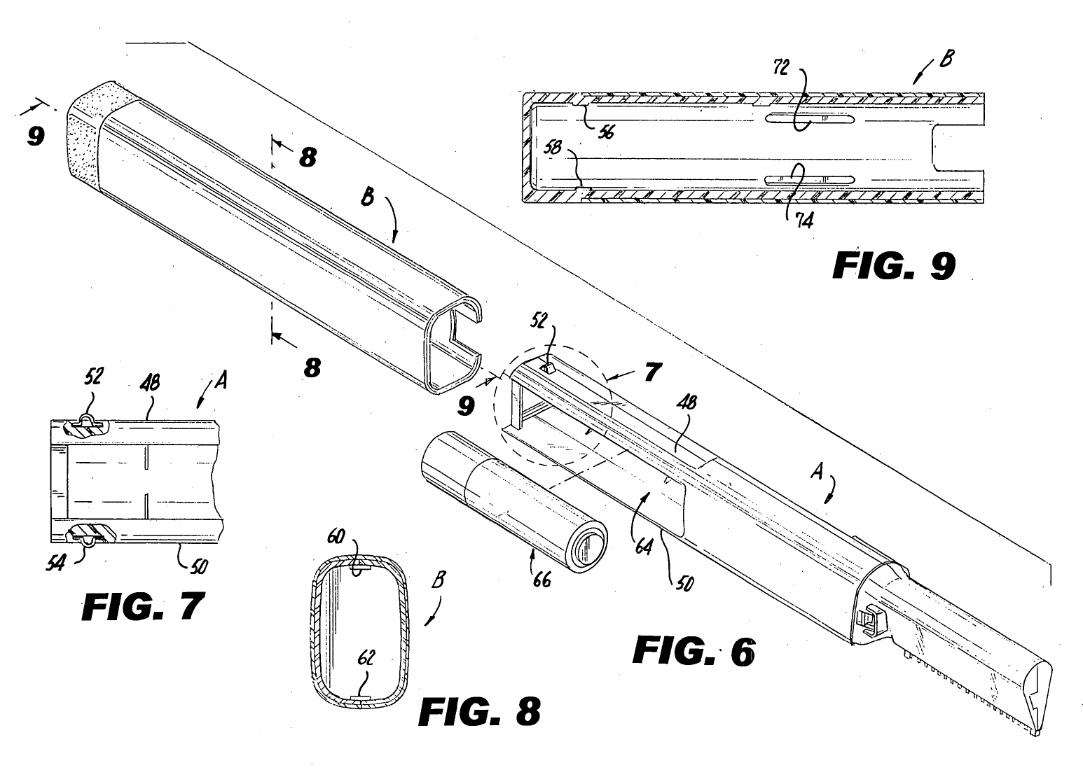

FIG. 6 illustrates the replacement position of handle B. In that position, the handle is spaced from housing A, in order to expose recess 64 to permit removal and insertion of a battery 66.

As seen in FIG. 3, a pair of spaced, elongated recesses 68, 70 are present on the exterior surface of housing A. As shown in FIG. 9, the interior surface of handle B is provided with spaced elongated ribs 72, 74. Ribs 72, 74 cooperate with recesses 68, 70 to guide the movement of the handle relative to the housing.

It will now be appreciated that the present invention relates to a trimmer designed to facilitate the removal of hair from hard to reach areas of the body. To do so, the trimmer is provided with an extendable handle to increase the reach of the trimmer. It is also provided with a moveable guide to protect the skin from direct contact with the blades.

While only a single preferred embodiment of the present invention has been disclosed for purposes of illustration, it is obvious that many variations and modifications could be made thereto. It is intended to cover all of those variations and modifications that fall within the scope of the present invention, as defined by the following claims:

We claim:

1. A hair trimmer comprising a housing, a moveable blade mounted on said housing and a handle having a recess into which at least a part of said housing is slideably received, said handle being moveable relative to said housing between a retracted position and an extended position, so as to increase the reach of the trimmer.

2. The trimmer of claim 1 further comprising detent means operably interposed between said handle and said housing.

3. The trimmer of claim 2 further comprising detent means engaging means.

4. The trimmer of claim 2 wherein said detent means comprising first and second oppositely directed detents.

5. The trimmer of claim 3 wherein said detent means engaging means comprises first and second oppositely directed protrusions.

6. The trimmer of claim 4 wherein said housing comprises oppositely facing exterior surfaces and wherein said first and second detents are mounted on said exterior surfaces, respectively.

7. The trimmer of claim 5 wherein said handle comprises oppositely facing interior surfaces and wherein said first and second protrusions are mounted on said interior surfaces, respectively.

8. The trimmer of claim 1 wherein said housing has a recess adapted to receive a battery and said handle is moveable relative to said housing to expose said battery receiving recess.

9. The trimmer of claim 1 further comprising a guide mounted on said housing, proximate said blade.

10. The trimmer of claim 9 further comprising means for mounting said guide for movement relative to said housing between a retracted position, wherein said blade is exposed and an extended position, wherein said guide extends beyond said blade.

11. The trimmer of claim 9 wherein said guide has a comb-like configuration.

12. The trimmer of claim 9 wherein said guide comprises a base and a plurality of spaced teeth extending from said base.

13. The trimmer of claim 12 wherein said base comprises a protruding member and said housing comprises an elongated slot adapted to moveably receive said member.

14. The trimmer of claim 13 wherein said member comprises a transversely extending head and wherein said slot comprises a transversely extending portion adapted to receive said head of said member.

15. The trimmer of claim 1 wherein said housing comprises a recess adapted to receive said guide when said guide is in the retracted position.

16. A hair trimmer comprising a housing, a moveable blade mounted on said housing, a guide and means for mounting said guide for movement relative to said housing between a retracted position, wherein said blade is exposed, and an extended position, wherein said guide extends beyond said blade.

17. The trimmer of claim 16 wherein said guide has a comb-like configuration.

18. The trimmer of claim 16 wherein said guide comprises a base and a plurality of spaced teeth extending from said base.

19. The trimmer of claim 18 wherein said teeth have an exterior surface and said exterior surface is arcuate.

20. The trimmer of claim 16 wherein said guide mounting means comprises a protrusion on one of said guide and said housing and an elongated slot on the other of said guide and said housing.

21. The trimmer of claim 20 wherein said protrusion comprises a transversely extending head and wherein said slot comprises a transversely extending portion adapted to receive said head of said member.

22. The trimmer of claim 16 wherein said housing has a recess adapted to substantially receive said guide, when said guide is in the retracted position.

23. The trimmer of claim 16 wherein said blade reciprocates in a first direction and said guide is moveable in a second direction and wherein said directions are substantially perpendicular to each other.

24. The trimmer of claim 16 further comprising an extendable handle.

25. A hair trimmer comprising a housing, a moveable blade mounted on said housing, a handle having a recess into which at least a part of said housing is slideably received, said handle being moveable relative to said housing between a retracted position and an extended position, a guide and means for mounting said guide for movement relative to said housing between a retracted position, wherein said blade is exposed and an extended position wherein said guide extends beyond said blade.
